(19) United States
(12) Patent Application Publication
(10) Pub. No.: US 2006/0205459 A1
(43) Pub. Date: Sep. 14, 2006

(54) Portable hand-held entertainment system with connectivity to non-integrated displays

(75) Inventors: Steven Rehkemper, Chicago, IL (US); Jeffrey Rehkemper, Chicago, IL (US); Kerry Phillips, South Holland, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: REHCO LLC, Chicago, IL (US)

(21) Appl. No.: 11/328,733

(22) Filed: Jan. 10, 2006

Related U.S. Application Data
(63) Continuation-in-part of application No. 10/906,811, filed on Mar. 8, 2005.

(51) Int. Cl. A63F 13/00

(52) U.S. Cl. 463/1

(57) ABSTRACT

The present invention provides in one embodiment for an entertainment system that includes a first controller having a hand-held body, a first plurality of operation members positioned for external manipulation, and an integral display included in the hand-held body. The first controller includes capability to generate content. The content is controlled in accordance to a program and/or input received from the first plurality of operation members. The content includes data for display on the integral display and data for display on a display that is non-integral to the first controller. Furthermore, an interface may be provided from first controller to the non-integral display such that the data is capable of being displayed thereon.

### CROSS REFERENCE TO RELATED APPLICATIONS

The present invention is a continuation in part of U.S. application Ser. No. 10/906,811 filed Mar. 8, 2005 entitled “Interactive Controller with an Integrated Display and Interface to a Second Controller with Stand-alone Display.”

### FIELD OF THE INVENTION

The present invention relates to an entertainment system that includes a portable hand-held entertainment system with an integral display that further communicates to a non-integral display.

### BACKGROUND OF THE INVENTION

Portable hand-held game or entertainment units are well known in the industry; such units include a primary display, integrated circuit(s) for running programs, storing information, and/or displaying visual graphics on the primary display, and a control mechanism for a user to interact and/or control the game play, information, or other data on the hand-held unit. The hand-held units are mostly designed for playing games, however, other hand-held units known in the industry include PDA's, music players, wireless email devices, and any other electronic consumer devices.

While these entertainment units are known, the level of interactivity or connectivity to other devices is limited. U.S. Pat. No. 6,773,349 discloses a hand-held controller with an integrated or removable display. However, the '349 patent has many limitations. For example, the hand-held controller links with a main entertainment game console or system. The main entertainment system includes all the programming and circuits to create a game that is controlled through the hand-held controller. The display on the hand-held controller is only capable of displaying video images created by the main entertainment system. The hand-held controller is incapable of functioning as a stand-alone unit.

Other entertainment systems are found in the prior art, for example, U.S. Pat. No. 6,931,656 provides for a virtual creature that is displayed on a television screen. The virtual creature is capable of transitioning between different states that are controlled by various events in the audio or video signals from the actual video program on the television. The control of the virtual creature is done more through programming controls then through a hand-held controller. Moreover, any hand-held controller units discussed in the '656 patent do not provide for an integrated LCD screen with functionality to entertain a user separate and apart from the television set.

Various other entertainment systems such as those found in U.S. Pat. Nos. 5,937,329; 6,510,557; and 5,610,665; are designed to provide satellite communication of community systems do not provide for a hand-held entertainment system with an integrated display to provide the user with a first instance of entertainment and that is further capable of communicating with a non integrated display to provide the user with a second instance of entertainment. The present invention creates two separate and distinct instances of entertainment: one portable, light weight and inexpensive and a second robust, enriched, and enlarged entertainment.

### SUMMARY OF THE INVENTION

In accordance with one embodiment of the present invention there is provided an entertainment system that includes a first controller having a hand-held body, a first plurality of operation members positioned for external manipulation, and an integral display included in the hand-held body. The first controller includes the capability to generate content. The content is controlled in accordance to a program and/or input received from the first plurality of operation members. The content has or includes graphic and/or audio information or data. The information or data may be generated or converted into any type of signal or format needed for playing the content, such as but not limited to digital, analog, wav, mpeg, mov, etc. The content includes data for display on the integral display and data for display on a display that is non-integral to the first controller. Furthermore, an interface is provided from the first controller to the non-integral display such that data is capable of being displayed thereon or emitted therefrom.

In another embodiment, a second controller is provided with a larger body than the first controller. The first controller when operably connected to the second controller communicates information and/or power between the two controllers such that the content is controlled with a plurality of second operation members on the second controller. The second controller in this embodiment communicates with the non-integral display, whereby data is communicated from the first controller through the second controller to the non-integral display.

In another embodiment, a first controller communicates with an interface control unit, which is in communication with a non-integral display. The first controller has its own display and generates first content with data for display on the integral display. The interface control unit receives input commands from the first controller to generate second content. The second content includes data for display on the non-integral display.

In yet another embodiment, a first controller slides into a second larger controller. The second larger controller communicates its input to an interface control unit for the generation of second content.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 illustrates a first controller with an integral display in wireless communication with an interface that is in wired communication with a non-integral display;

FIG. 2; illustrates a first controller with an integral display in wired communication with a non-integral display;

FIG. 3 illustrates a first controller with an integral display that has an operable connection to a second controller, the second controller is in wired communication with a non-integral display;

FIG. 4 illustrates a first controller with an integral display that has an operable connection to a second controller, the second controller is in wireless communication with an interface, which is in wired communication with a non-integral display; and

FIG. 5 is a block diagram of an entertainment system in accordance with FIG. 3.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

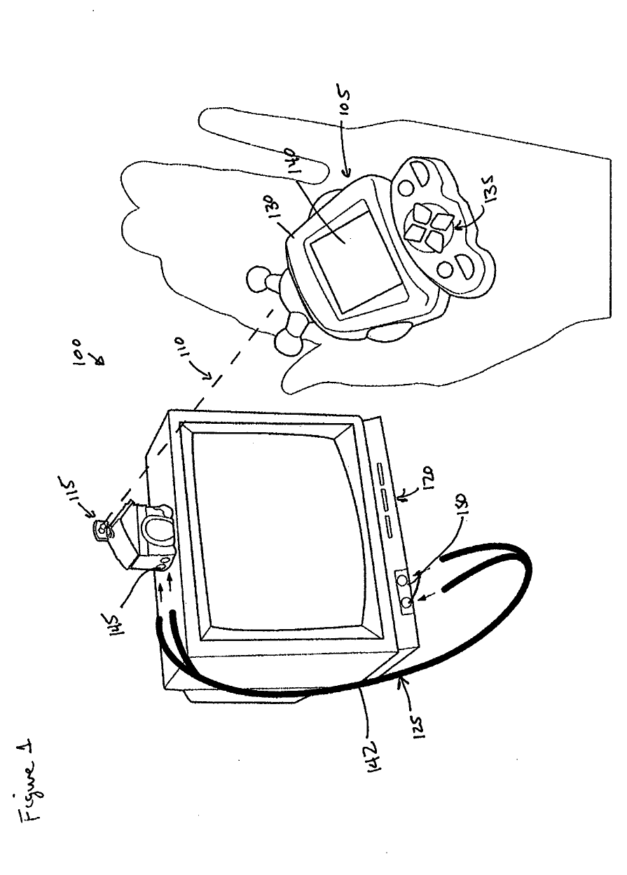

Referring now to FIG. 1, an entertainment system 100 includes a first controller 105 with a first means to communicate 110 with an interface control unit 115. The interface control unit 115 is further in communication with a stand-alone display 120 via a second communication means 125. In the present embodiments, the stand-alone display 120 is shown as a television set, however, any monitor or display may be utilized as a stand-alone display for purposes of the present invention as long as the display is non-integral to the first controller 105.

As further illustrated in FIG. 1, the first controller 105 includes a hand-held body 130 with a plurality of operation members or buttons 135. The operation members 135 are positioned on the outside of the body 130 for external manipulation by a user. The hand-held body 130 further includes an integral display 140. The integral display 140 is a Liquid Crystal Display or LCD as commonly referred. A speaker (not shown) may also be included in the hand-held body for emitting any audio data. A power supply (not shown) would also be included along with various electrical components, programming, memory, processor(s), thereby providing a first controller 105 that is considered a portable hand-held entertainment system within itself. The first controller 105 may play games, provide email information, sports or news wires, play music and/or videos, act as a pager, PDA, or phone. The type of information stored, played, or received by the first controller 105 does not limit the scope of the present invention. The first controller 105 is simply provided as a portable, electronic device that includes an integral display.

In the first embodiment, the first controller 105 generates first content in accordance to a program or programs and/or in accordance to the input received from the operation members 135. The generated content if for a video game would be considered interactive or evolving with a play pattern designed in the programming. In any environment, the generated content would at least include graphic and/or audio information or data. The information or data may be generated or converted into any type of signal or format needed for playing the content, such as but not limited to digital, analog, wav, mpeg, mov, etc. The content would include data for display on the integral display 140 and data for emitting through the speaker (or headphones). The content may even include vibrations or other motorized movement (such as that found in email alerts or more sophisticated gaming systems).

As mentioned, the first controller 105 communicates with an interface control unit 115. The means of communication 110 is shown as a wireless communication facilitated by well known wireless components such as a transmitter/receiver. However, it is extremely well known in the industry to provide for wired communication rather than wireless communication. The components needed to facilitate either modes of communication are widely available and known in the art, such that further reference is not needed. However, what does become important is the information being communicated from the first controller 105 to the interface control unit 115.

In the first embodiment, the first controller 105 communicates the input commands received from the operation members 135 to the interface control unit 115. The interface control unit includes programming and electronic components to generate a second content. The second content is generated in accordance with programming in the interface control unit 115 and the input commands received from the first controller 105. The second content would include information or data (as explained above) that is communicated through the second communication means 125 to the non-integral display 120.

In the present invention, the second communication means 125 would include cable or wires 142 from output ports 145 on the interface control unit 115 to input ports 150 on the second non-integral display 120. The wires 142 being removable as needed by the user.

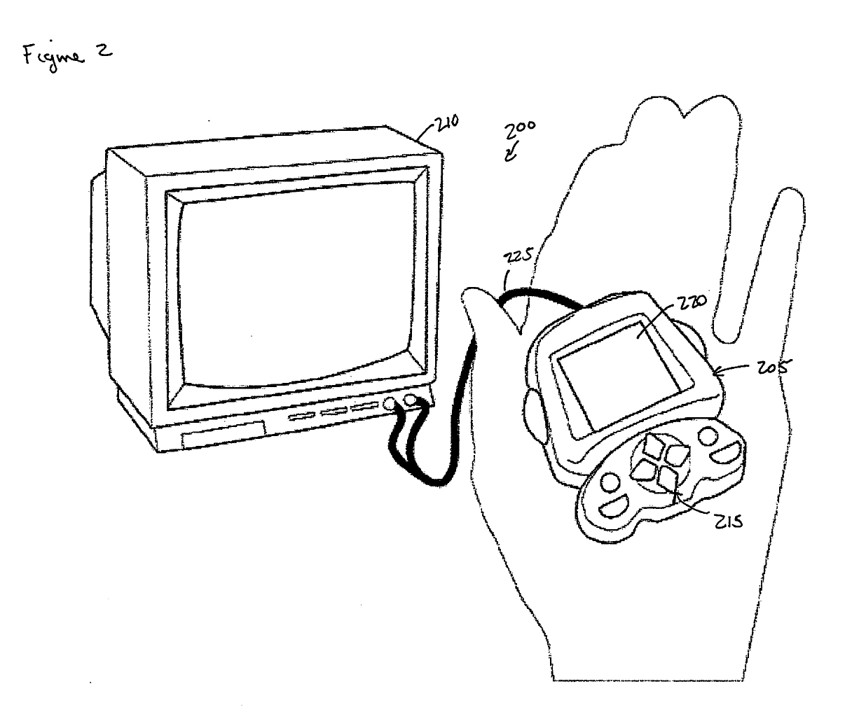

Referring now to FIG. 2, it being further contemplated by the present invention to provide the entertainment system 100, as described above and as illustrated in FIG. 1, but provided as a more compact, portable unit. As such, FIG. 2 illustrates a second entertainment system 200 that includes a first controller 205 that is in communication with a non-integral display 210. The first controller 205 includes a plurality of operation members 215 for external manipulation by a user. The first controller 205 includes a means to generate content in accordance to a program (or programs) and/or in accordance to input received from the operation members. The content would include data for display on a first integral LCD 220. When not connected to the non-integral display 210, the first controller 205 provides for a complete and interactive entertainment device (such as described above as a video game system, PDA, music player, etc).

As mentioned, however, the first controller 205 is connectable via wires 225 to a non-integral display 210. The content generated by the first controller 205 would include data for display on the non-integral display 210 and data for emitting through the speakers within the non-integral display 210. Therefore, the first controller 205 would generate data for the non-integral display 210 and is able to be directly connectable to the non-integral display 210.

The data for display on the integral display may be different from the data for display on the non-integral display or the data may be identical. Either event would not limit the scope of the invention.

As it is well known that an LCD display would receive digital graphics and the non-integral display such as a television may require analog graphics, the content being generated by the first controller 205 would (in that specific environment) generate analog and digital graphics. The components needed to facilitate the generation of the signals being well known in the industry do not require further reference. However, if the non-integral display is a digital display the data communicated thereto may be digital graphics.

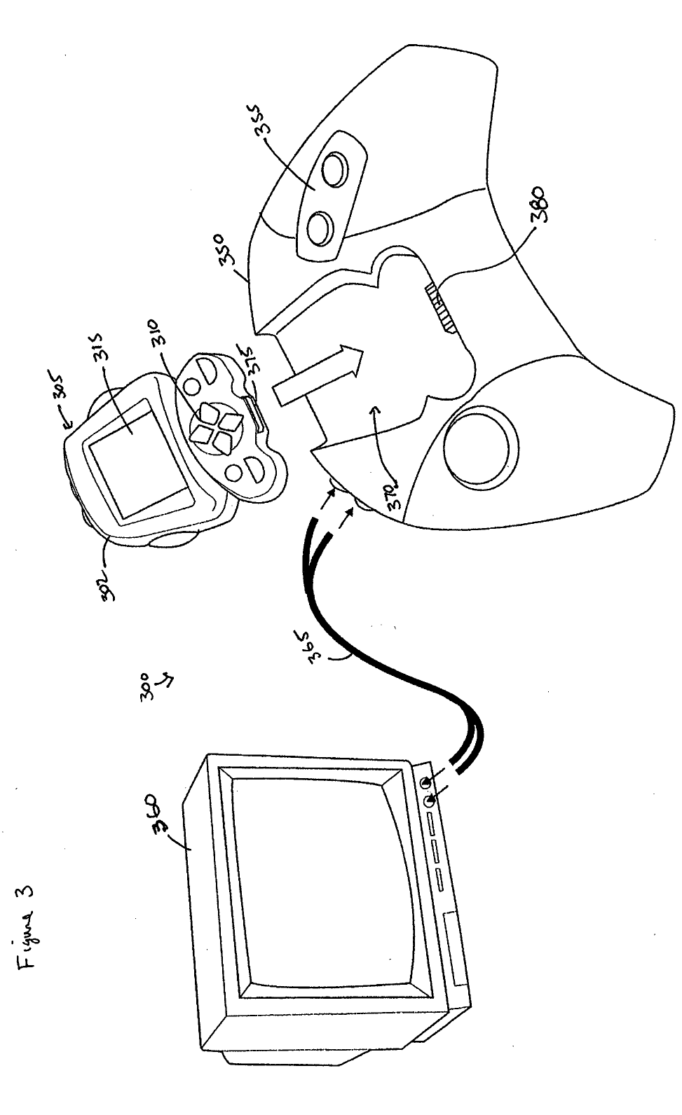

In a third embodiment illustrated in FIG. 3, a third entertainment system 300 is provided to include a first controller 305. The first controller 305 includes a hand-held body 302, a plurality of first operation members 310 and an integral display 315. The first controller 305 would also include a power supply (not shown) such that the first controller 305 is useable as its own portable entertainment device. The first controller 305 would generate at least first content in accordance to programming and/or input received from the first operation members 310. The first content including data for display on the integral display 315.

The third entertainment system 300 also includes a larger second controller 350 with a plurality of second operation members 355. The second controller 350 is in communication with a non-integral display 360, preferably by a wire or wires 365. The first and second controllers 305 and 350, respectively, are operably connected to each other such that information may pass from the two controllers and to the second non-integral display 360. For example, when connected input from the operation members 355 from the second controller 350 will pass to the first controller 305, such that the content can be generated. The data (graphic and/or audio) will then pass from the first controller 305 through the second controller 350 to the non-integral display 360 via the wires 365. The power in the first controller 305 may also pass to the second controller 350, or the second controller 350 may include a separate power supply.

To operably connect the two controllers, the second controller 350 includes a slot 370, or docking station, sized to accommodate at least a portion of the body 302 of the first controller 305. A first connector 375 on the first controller 305 communicates with a second connector 380 on the second controller 350. Various well known connectors to provide for an electrical connection and/or to provide the exchange of information and power may be used. This illustration and description provides but for a single means of connecting the two controllers, numerous methods can be used to operably connect the two controllers. The slot 370 is simply provided as a means to hold the first controller 305 in place when using the second controller 370, preventing the two controllers from accidentally becoming disconnected.

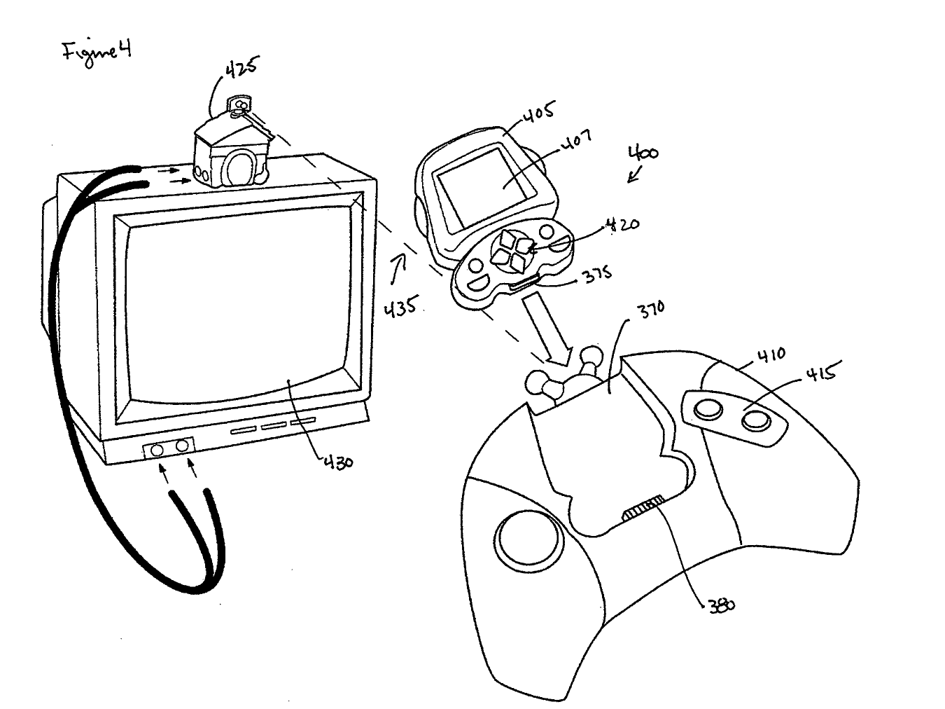

In a fourth embodiment, illustrated as a fourth entertainment system 400 in FIG. 4. A first controller 405 is provided to operably communicate with a second larger controller 410. The first controller 405 being completely portable and having the capability to be its own entertainment device has an integral display 407 and will generate first content with data for display on the integral display 407. But when plugged into the second controller, power from the first controller 405 is transferred to the second controller 410 such that the second controller 410 is able to send input commands (from a plurality of second operation members 415 and/or from a plurality of first operation members 420) to an interface control unit 425. The input commands are communicated through a wireless communication 435, however, wired communication is within the present scope of the invention.

The interface control unit 425 is in communication with a display 430 that is non-integral with the first controller 405. The interface control unit 425 will generate second content from a program stored in the interface control unit 425 and/or based upon the input commands received from the second controller 410. The second content will contain data for display on the non-integral display 430.

It is further contemplated by the present invention to provide the programming on a cartridge or other external storage medium that simply connects with the controller or interface units. This could provide a very expansive library of entertainment services such as games, music, information, etc.

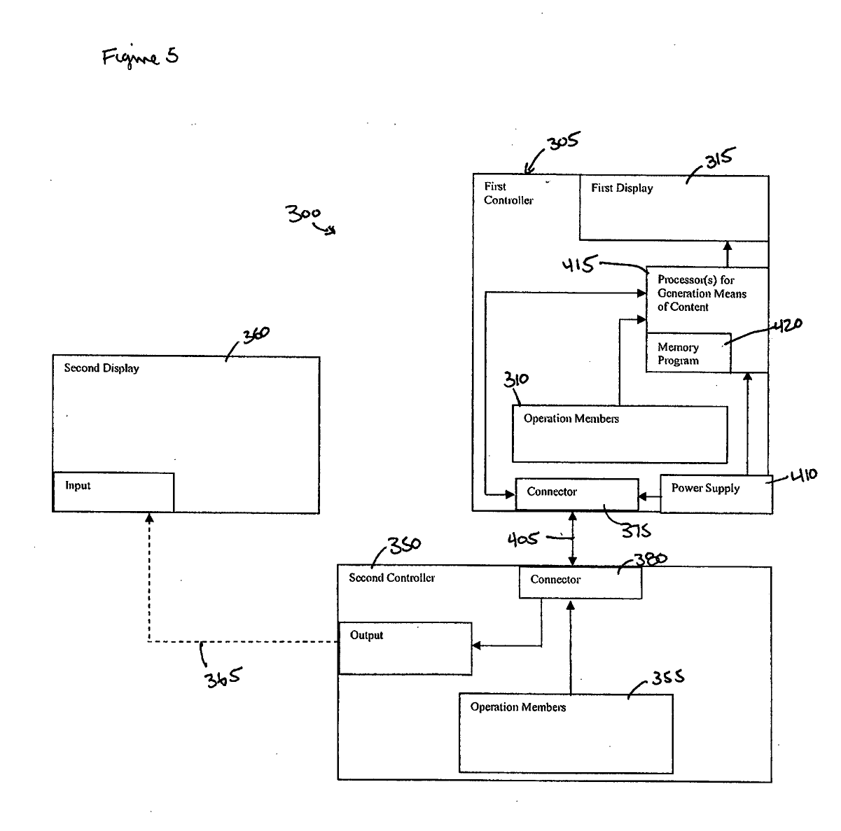

Referring now to FIG. 5, there is shown a block diagram provided especially for the third entertainment system 300, however, its applicability for the other embodiments would be apparent from its teachings. The first controller 305 communicates with a second controller 350 through the pair of connectors 375 and 380. When operably connected, power and information 405 can travel between the two controllers. The power would be obtained through the power supply 410, while the information is obtained from processor(s) 415. The processor(s) 415 would be designed to run the program(s) stored on a memory 420. As mentioned the memory 420 may be internal or external to the first controller. The processor(s) 415 would also generate the content that includes data for display on the integral display 315 and data that is communicated to the second controller and then out to the non-integral display 360. (Again, the data displayed on the integral display and the non-integral display may be the same or may be different.) The data for the non-integral display is preferably communicated through a wire or cable 365. The input from the second operation members 355 would also be communicated to the processor(s) 415 for the generation of the data when the two controllers are operably connected.

Moreover, it is further provided in any of the embodiments discussed herein that the integral LCD display is a smaller less expensive (and even possibly black/white) display than the non-integral display. The data would be created to utilize the graphic capabilities provided, thus the data generated for the non-integral display could be enhanced or have greater contrast, coloring, depth, and/or pixels than the data for display on the integral display. The entertainment system therefore provides for a first controller capable of operating separate and apart from the non-integral display to provide a hand-held portable entertainment system for use with the first integral display, and further provides for the first controller to be used in connection with a non-integral display to provide for a more enriched viewing display.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. An entertainment system comprising:
a first controller comprising a hand-held body, a first plurality of operation members positioned on the hand-held body for external manipulation, an integral display being included in said hand-held body,
a means to generate content, wherein the content is controlled in accordance to a program and/or input received from the first plurality of operation members, and the content includes first data for display on the integral display and includes second data for display on a display that is non-integral to the first controller, and
a means to interface said first controller to the non-integral display such that said second data is capable of being displayed thereon.

2. The entertainment system of claim 1, wherein the means to generate content includes at least a processor housed within said first controller.

3. The entertainment system of claim 2, wherein the interface means comprises an output port defined on the first controller and a wire connecting said output port to an input port defined on the non-integral display.

4. The entertainment system of claim 3, wherein the first controller further includes a second program to generate second content in accordance with said second program and/or based upon input received from the operation members on said first controller, and said second content includes the second data for display on the non-integral display.

5. The entertainment system of claim 4, wherein the non-integral second display is a television set.

6. The entertainment system of claim 5, wherein the first display is an LCD screen.

7. The entertainment system of claim 1, wherein the first data is identical to the second data.

8. An entertainment system comprising:
a first controller comprising a hand-held body, a first plurality of operation members positioned on the hand-held body for external manipulation, an integral display being included in said hand-held body, a means to generate content, wherein the content is controlled in accordance to a program and/or input received from the first plurality of operation members, and the content includes first data for display on the integral display, and
a second controller comprising a second hand-held body having a plurality of second operation members positioned for external manipulation, and the second hand-held body being larger than the first hand-held body defined by said first controller;
a means to operably connect said first controller to said second controller in order to communicate input received from the plurality of second operation members to the first controller, such that the means to generate content is able to generate second content on the first controller that is controlled by said plurality of second operation members, and said second content includes second data for display on a display that is non-integral to said first controller; and
a means to interface said second controller to the non-integral display such that said second data is capable of being displayed thereon.

9. The entertainment system of claim 8 further comprising:
a second program stored on said first controller and controlled to generate second content in accordance with the second program and/or input received from the second operation members, wherein the second content includes the second data for display on the non-integral display.

10. The entertainment system of claim 8, wherein said means to operably connect said first controller to said second controller includes:
a first connector on said first controller;
a slot on said body of said second controller sized to receive at least a portion of said first controller; and
a second connector within said slot for enabling said first controller to be operably connected via said first connector to said second controller, such that input from said second operation members is communicated through the first and second connectors to said generation means for the generation of at least the second data.

11. The entertainment system of claim 8, wherein the means to interface said second controller to the non-integral display includes an input port on the second controller, a wire connecting said output port to an input port defined on the non-integral display, and wherein the second data are communicated from said first controller to said second controller through the first and second connectors such that said second data is capable of being displayed on said non-integral display.

12. The entertainment system of claim 8, wherein the first data is identical to the second data.

13. An entertainment system comprising:
a first controller comprising a hand-held body, a first plurality of operation members positioned on the hand-held body for external manipulation, an integral display being included in said hand-held body, first content generated in accordance to a first program and/or in accordance to input received from the first plurality of operation members, said first content includes first data for display on said integral display;
a second controller comprising a second hand-held body having a plurality of second operation members positioned for external manipulation, and the second hand-held body defined by the second controller being larger than the first hand-held body defined by said first controller;
a means to operably connect said first controller to said second controller;
an interface control unit that is capable of being operatively connected to a display that is non-integral to the first controller;
a means to communicate input from either the manipulation of the plurality of the first operation members or from the manipulation of the plurality of the second operation member from the second controller to the interface control unit; and
second content generated in accordance to a second program and/or in accordance to input received from the second controller, said second content includes second data generated for display on the non-integral display when said interface control unit is operatively connected thereto;
whereby said first controller is capable of operating separate and apart from said second controller to provide a hand-held portable entertainment system for use with said integral display, and whereby said first controller when operably connected to said second controller provides for a second hand-held entertainment system for use with the non-integral display.

14. The system of claim 13, wherein said means to operably connect said first controller to said second controller includes:
a first connector on said first controller, said first connector in communication with said first processor;
a slot on said body of said second controller sized to receive at least a portion of said first controller;
a second connector within said slot for enabling said first controller to be operably connected via said first connector to said second controller.

15. The system of claim 13, wherein the communication means includes a wireless transmitter in the second controller and a wireless receiver in the interface control unit.

17. The system of claim 13, wherein the interface control unit includes a communication cable capable of operatively connecting from said interface control unit to the non-integral display for the communication of said data.

18. The system of claim 13, wherein the first controller includes a power supply and said power supply is transferred to said second controller through said first and second connectors when said first controller is operably connected to said second controller.
